(19) United States
(12) Patent Application Publication
(10) Pub. No.: US 2007/0036917 A1
(43) Pub. Date: Feb. 15, 2007

(54) Liquid crystal display device

(75) Inventor: Junichi Hirakata, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-ashigara-shi (JP)

(21) Appl. No.: 11/502,523

(22) Filed: Aug. 11, 2006

(30) Foreign Application Priority Data
Aug. 12, 2005 (JP) 234684/2005

(51) Int. Cl. C09K 19/00

(52) U.S. Cl. 428/1.31

(57) ABSTRACT

A liquid crystal display device comprising a liquid crystal cell containing a nematic liquid crystal material aligned nearly in parallel to the surfaces of the cell at the time of no voltage application thereto, and two polarizers disposed on both outer sides of the liquid crystal cell, wherein the optically anisotropic layer comprising a hybrid-aligned compound is disposed between the liquid crystal cell and one of the polarizers and the alignment control direction of the hybrid-aligned compound is nearly in parallel to absorption axis of any one of the polarizers.

### BACKGROUND OF THE INVENTION

1. Field of the Invention

The present invention relates to a parallel-aligned liquid crystal display device such as typically an IPS (in-plane switching) mode liquid crystal display device.

2. Description of the Related Art

A liquid crystal display device comprises a liquid crystal cell and a polarizing plate. The polarizing plate comprises a protective film and a polarizer (polarizing film). In general, the polarizing plate is obtained by coloring a polarizer of a polyvinyl alcohol film with iodine, stretching it and then laminating a protective film on both faces thereof. A transmission liquid crystal display device may comprise such a polarizing plate fitted to both sides of the liquid crystal cell thereof, and may further has one or more optical compensatory sheets (films) disposed therein. On the other hand, a reflection liquid crystal display device may generally comprise a reflector, a liquid crystal cell, one or more optical compensatory sheets and a polarizing plate disposed in that order. The liquid crystal cell comprises liquid crystalline molecules, two substrates for sealing them in, and an electrode layer for imparting voltage to the liquid crystal line molecules. Depending on the alignment state of the liquid crystal molecules therein, the liquid crystal cell acts for ON/OFF display. The liquid crystal cell are applicable to both transmission and reflection display devices, for which proposed are various display modes of TN (twisted nematic), ISP (in-plane switching), OCB (optically compensatory bend), VA (vertically aligned), ECB (electrically controlled birefringence) and ferroelectric liquid crystal display modes.

An optical compensatory sheet is used in various liquid crystal display devices for canceling image coloration and for enlarging a viewing angle. For such an optical compensatory sheet, a stretched birefringent polymer film is heretofore used. In place of the optical compensatory sheet formed of such a stretched birefringent film, a method is proposed of providing an optical compensatory sheet formed of low molecular or high molecular liquid crystal line molecules, on a transparent support. Using liquid crystalline molecules and utilizing diverse alignment states thereof realizes optical properties which conventional stretched birefringent polymer films could not obtain. Further, also proposed is imparting birefringence to the protective film of a polarizing plate so as to realize a constitution that acts both as a protective film and an optical compensatory sheet.

The optical properties of the optical compensatory film may be determined depending on the optical properties of the liquid crystal cell, concretely on the difference between the display modes as above. Using liquid crystalline molecules makes it possible to produce an optical compensatory sheet having various optical properties in accordance with various display modes of liquid crystal cells. Various optical compensatory sheets comprising liquid crystalline molecules have already been proposed in accordance with various display modes.

It is important to broaden the viewing angle of liquid crystal display devices. Recently, however, liquid crystal display devices have become used in various applications, and for example, in display devices in mobile phones and mobile terminals (notebook-size personal computers), it may be often necessary to narrow the viewing angle for preventing peeping. Specifically, it may be necessary to broaden the viewing angle in the vertical direction and to narrow the viewing angle in the horizontal direction. For it, proposed are method of disposing an optical compensatory sheet and making its retardation variable so as to control the viewing angle (see JP-A-2005-37784), and a method of focusing the outgoing light of a backlight to thereby narrow the viewing angle in the horizontal direction (see JP-A-2001-305312).

However, the viewing angle-controlling film as above has some problems in that the viewing angle expansion in the vertical direction is insufficient and the front brightness lowers.

### SUMMARY OF THE INVENTION

The present invention has been made in consideration of the above-mentioned problems, and its object is to provide a liquid crystal display device, especially an IPS or ECB mode parallel-aligned liquid crystal display device which is designed simply and has a narrowed viewing angle in the horizontal direction and a broadened viewing angle in the vertical direction and of which the front brightness lowers little.

To solve the above-mentioned problems, the invention includes the following constitutions:

[1] A liquid crystal display device comprising

a liquid crystal cell that comprises a pair of substrates disposed to face each other and having an electrode on one side thereof, and a liquid crystal layer sandwiched between the substrates and containing a nematic liquid crystal material aligned nearly in parallel to the surfaces of the pair of substrates at the time of no voltage application thereto, and

two polarizing plates disposed on both outer sides of the liquid crystal cell,

wherein at least one of the polarizing plates comprises a polarizer and a protective film disposed on at least one surface of the polarizer, and an optically anisotropic layer is disposed between the liquid crystal cell and the polarizer provided that the optically anisotropic layer and one of the protective films may be the same, and

the optically anisotropic layer comprises a hybrid-aligned compound, and the alignment control direction of the hybrid-aligned compound is nearly in parallel to absorption axis of any one of the polarizers provided in the liquid crystal display device.

[2] The liquid crystal display device of [1], wherein the optically anisotropic layer is disposed on both sides of the liquid crystal cell.

[3] A liquid crystal display device comprising

a liquid crystal cell that comprises a pair of substrates disposed to face each other and having an electrode on one side thereof, and a liquid crystal layer sandwiched between the substrates and containing a nematic liquid crystal material aligned nearly in parallel to the surfaces of the pair of substrates at the time of no voltage application thereto,

two first polarizing plates comprising a polarizer and disposed on both outer sides of the liquid crystal cell, and

a second polarizing plate comprising a polarizer and an optically anisotropic layer and disposed outside the first polarizing plates,

wherein the second polarizing plate comprises a protective film disposed on at least one surface of the polarizer, and the optically anisotropic layer is disposed between the polarizer and the first polarizing plate provided that the optically anisotropic layer and one of the protective films in the second polarizing plate may be the same, and

the optically anisotropic layer comprises a hybrid-aligned compound, and the alignment control direction of the hybrid-aligned compound is nearly in parallel to absorption axis of any one of the polarizers provided in the liquid crystal display device.

[4] The liquid crystal display device of any of [1] to [3], wherein the alignment state of at least one optically anisotropic layer varies depending on the external field around it.

[5] The liquid crystal display device of any of [1] to [4], wherein the optically an isotropic layer comprises a compound having a discotic structural unit, and satisfies the following formulae:
0.5≦d≦3.0,
20≦β≦90,
10≦Q≦500,
in which d [μm] indicates the thickness of the optically anisotropic layer;
β [°] indicates the mean tilt angle of the hybrid-aligned compound in the optically anisotropic layer;
Q [nm] indicates the in-plane retardation of the optically anisotropic layer.

The invention has made it possible to provide a liquid crystal display device having the same constitution as that of conventional liquid crystal display devices and having a function of optically compensating the liquid crystal cell therein. Further, the liquid crystal display device of the invention has made it possible to prevent peeping as the brightness thereof in the horizontal direction at the time of black level of display is increased and the viewing angle thereto is narrowed. The display device keeps a broad viewing angle in the horizontal direction, intrinsic to conventional IPS mode display devices. Further, the front brightness of the display device is not lowered, and the invention thus provides a bright IPS mode liquid crystal display device.

### BRIEF DESCRIPTION OF THE DRAWINGS

FIG. 1 is a schematic view showing one example of the liquid crystal display device of the invention.

FIG. 2 is a schematic cross-sectional view of FIG. 1.

FIG. 3 is a schematic cross-sectional view showing another example of the liquid crystal display device of the invention.

FIG. 4 is a schematic view showing light leakage through a conventional polarizing plate.

In these drawings, 1 is an upper polarizing plate; 2 is the absorption axis of the upper polarizing plate; 3 is an upper protective film; 4 is the slow axis of the upper protective film; 5 is an upper substrate of a liquid crystal cell; 6 is the rubbing direction of the upper substrate for liquid crystal alignment; 7 is a liquid crystalline molecule; 8 is a lower substrate of the liquid crystal cell; 9 is the rubbing direction of the lower substrate for liquid crystal alignment; 10 is a lower optically anisotropic layer; 11 is the alignment control direction of the lower optically anisotropic layer; 12 is a lower protective film; 13 is the slow axis of the lower protective film; 14 is a lower polarizing plate; 15 is the absorption axis of the lower polarizing plate; 16 is a linear electrode; 30 and 42 each are a polarizing plate; 32 and 40 each are a transparent substrate; 34 is a rod-shaped liquid crystalline molecule; 36 is the direction of an electric field; 38 is a linear electrode; 44 is an insulating layer; 46 is a lower electrode.

### BEST MODE FOR CARRYING OUT THE INVENTION

The invention is described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

The terms as referred to herein are described.

(Retardation, Re, Rth)

In the invention, Re(λ) is an in-plane retardation of a film, and this is determined by applying light having a wavelength of λ to a film in the normal direction of the film, using KOBRA 21ADH (by Oji Scientific Instruments). Rth(λ) is a retardation in the thickness direction of a film, and this is determined as follows: Based on three retardation data, or that is, Re(λ) as above, a retardation value measured by applying light having a wavelength of λ nm to the sample in the direction tilted by +40° relative to the normal direction of the film with the slow axis (judged by KOBRA 21ADH) as the tilt axis (rotation axis) thereof, and a retardation value measured by applying light having a wavelength of λ nm to the sample in the direction tilted by −40° relative to the normal direction of the film with the slow axis as the tilt axis (rotation axis) thereof, and on the estimated value of the mean refractive index of the sample and the inputted thickness of the sample, Rth(λ) is computed by KOBRA 21ADH. For the estimated value of the mean refractive index of films to be analyzed, for example, referred to are Polymer Handbook (by John Wiley & Sons, Inc.) and various catalogues of optical films. When the mean refractive index of the sample is unknown, it may be measured with an Abbe's refractiometer. Data of the mean refractive index of some typical optical films are mentioned below: Cellulose acylate (1.48), cycloolefin polymer (1.52), polycarbonate (1.59), polymethyl methacrylate (1.49), polystyrene (1.59). When the estimated value of mean refractive index and the thickness of the sample are inputted therein, then KOBRA 21ADH computes nx, ny and nz. The thus-computed data nx, ny and nz give Nz=(nx−nz)/(nx−ny).

(Molecular Alignment Axis)

A sample having a size of 70 mm×100 mm is conditioned at 25° C. and 65% RH for 2 hours. Using an automatic birefringence meter (KOBRA21DH, by Oji Scientific Instruments), the incident angle of vertical light application is varied and the molecular alignment axis is computed from the phase retardation.

(Axial Shift)

The angle of axial shift is measured, using an automatic birefringence meter (KOBRA 21DH, by Oji Scientific Instruments). The sample is measured at 20 points at regular intervals in the cross direction of the entire width thereof, and the mean value of the absolute data is obtained. The range of the slow axis angle (axial shift) is determined as follows: The sample is measured at 20 points at regular intervals in the cross direction of the entire width thereof, and a mean difference is obtained between the mean value of the four points taken from the side having a larger absolute value of axial shift, and the mean value of the four points taken from the side having a smaller absolute value of axial shift.

(Transmittance)

Using a transmittance meter (AKA photocell calorimeter, by Kotaki Manufacturing) at 25° C. and 65% RH, the transmittance of a sample having a size of 20 mm×70 mm is determined with visible light (615 nm).

(Spectral Characteristics)

Using a spectrophotometer (U-3210, by Hitachi), the transmittance of a sample having a size of 13 mm×40 mm is determined at 25° C. and 60% RH within a wavelength range of from 300 to 450 nm. The tilt angle is obtained as (wavelength for 72% transmittance-wavelength for 5% transmittance). The limit wavelength is represented by a wavelength for (tilt width/2)+5%. The absorption end is represented by the wavelength for 0.4% transmittance. From these, the transmittance at 380 nm and 350 nm is evaluated.

“45 degrees”, “parallel” and “vertical” as referred to herein each means a range of the strict angle ± less than 5 degrees, or that is, they mean about 45 degrees, nearly parallel and nearly vertical, respectively. Preferably, the error from the strict angle is less than 4 degrees, more preferably less than 3 degrees. Regarding the angle, “+” means a clockwise direction; and “−” means a counterclockwise direction. “Slow axis” means the direction in which the refractive index is the largest. “Visible light region” is from 380 nm to 780 nm. Unless otherwise specifically indicated, the wavelength for refractive index measurement is λ=550 nm within a visible light range.

In this description, “polarizing plate” is meant to include both a long-size polarizing plate and a polarizing plate cut to have a size capable of being built in liquid crystal display devices (in this description, “cut” is meant to include both “blanking” and “ordinary cutting”), unless otherwise specifically indicated. In this description, “polarizer” and “polarizing plate” are differentiated; and the “polarizing plate” means a laminate that comprises a “polarizer” and a transparent protective film formed on at least one surface of the “polarizer” to protect it. In this description, the polarizing plate may include an optical compensatory sheet. In the invention, an optically anisotropic layer may serve also as the protective film.

The liquid crystal display device of the first embodiment of the invention comprises a liquid crystal cell that comprises a pair of substrates disposed to face each other and having an electrode on one side thereof, and a liquid crystal layer sandwiched between the substrates and containing a nematic liquid crystal material aligned nearly in parallel to the surfaces of the pair of substrates at the time of no voltage application thereto, and two polarizing plates disposed on both outer sides of the liquid crystal cell,

wherein at least one of the polarizing plates comprises a polarizer and a protective film disposed on at least one surface of the polarizer, and an optically anisotropic layer is disposed between the liquid crystal cell and the polarizer provided that the optically anisotropic layer and one of the protective films may be the same, and

the optically anisotropic layer comprises a hybrid-aligned compound, and the alignment control direction of the hybrid-aligned compound is nearly in parallel to absorption axis of any one of the polarizers provided in the liquid crystal display device.

This is hereinafter referred to as “liquid crystal display device I”.

The liquid crystal display device of the second embodiment of the invention comprises a liquid crystal cell that comprises a pair of substrates disposed to face each other and having an electrode on one side thereof, and a liquid crystal layer sandwiched between the substrates and containing a nematic liquid crystal material aligned nearly in parallel to the surfaces of the pair of substrates at the time of no voltage application thereto, two first polarizing plates comprising a polarizer and disposed on both outer sides of the liquid crystal cell, and a second polarizing plate comprising a polarizer and an optically anisotropic layer and disposed outside the first polarizing plates,

wherein the second polarizing plate comprises a protective film disposed on at least one surface of the polarizer, and the optically anisotropic layer is disposed between the polarizer and the first polarizing plate provided that the optically anisotropic layer and one of the protective films in the second polarizing plate may be the same, and

the optically anisotropic layer comprises a hybrid-aligned compound, and the alignment control direction of the hybrid-aligned compound is nearly in parallel to absorption axis of any one of the polarizers provided in the liquid crystal display device.

This is hereinafter referred to as “liquid crystal display device II”.

The liquid crystal display device of the invention may indicate both the liquid crystal display devices I and II.

The constitutive members of some embodiments of the liquid crystal display device of the invention are described in order.

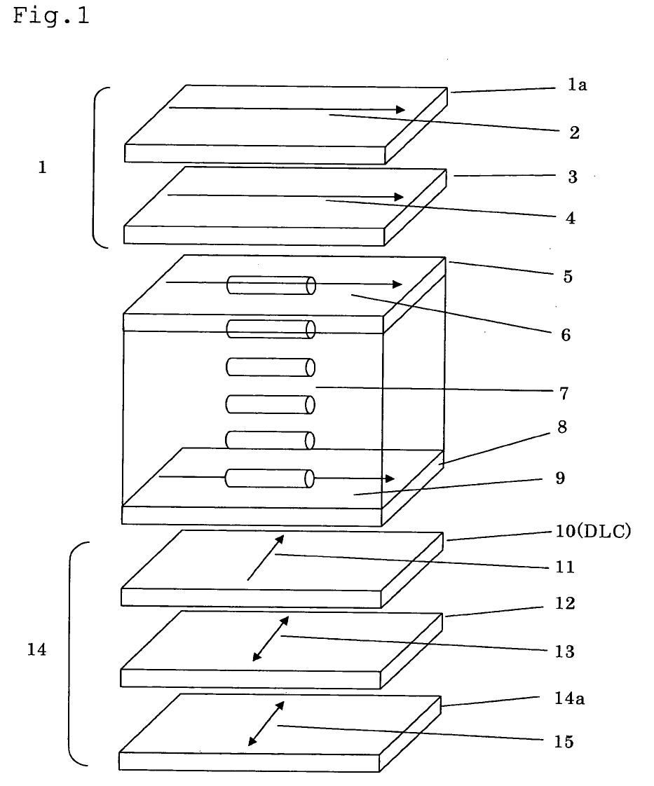

FIG. 1 is a schematic view of one embodiment of the liquid crystal display device of the invention.

In FIG. 1, the liquid crystal display device comprises a liquid crystal cell 5 to 9, and a pair of polarizing plates 1 and 14 disposed on both sides of the liquid crystal cell. The polarizing plate 1 comprises a polarizer and a transparent protective film/film(s) disposed on one side of the film toward the liquid crystal cell or disposed to sandwich the polarizer therebetween. In FIG. 1, the polarizer of the upper polarizing plate 1 and the protective film disposed on the upper side of the polarizer are integrated together (1a); and the polarizer of the lower polarizing plate 14 and the protective film disposed on the lower side of the polarizer are integrated together (14a), and their detailed structures are omitted herein. Between the liquid crystal cell and the pair of polarizing plates, disposed are an upper protective film 3 (functioning as an optically anisotropic layer) having an optical compensatory capability; a lower protective film 12; and an optically anisotropic layer 10 formed of a discotic compound. The upper protective film (not shown) of the upper polarizing plate 1 and the upper protective film 3 form a pair structure, or that is, the upper polarizing plate 1 is built in the liquid crystal display device as an integrally-laminated structure of the members 1a to 4. On the other hand, the protective film 12 on the side of the liquid crystal cell of the lower polarizing plate 14 serves also as the support of the optically anisotropic layer 10, or that is, the lower polarizing plate 14 is built in the liquid crystal display device as an integrally-laminated structure of the members 10 to 15. The embodiemnt of FIG. 1 has an optically anisotropic layer on both sides of the liquid crystal cell, but the liquid crystal display device I should not be limited to this embodiment. In this, the optically anisotropic layer disposed on at least one side of the liquid crystal cell may be the above-mentioned predetermined optically anisotropic layer. The liquid crystal display device of the invention may have two or more optically anisotropic layer on one side of the liquid crystal cell therein.

In the invention, at least one polarizing plate may be a laminate of a polarizer and an optically anisotropic layer (for example, the upper polarizing plate is a laminate of an upper polarizer and a protective film), and it is not always necessary that the two polarizing plates both have the laminate of the above-mentioned constitution as in FIG. 1. In the embodiment of the liquid crystal display device of FIG. 1, the polarizing plate has an integrally two-layered laminate structure of an optically compensatory film and one protective film, but the invention should not be limited to this embodiemnt. Accordingly, for example, in the liquid crystal display device of the invention, a polarizing plate and at least one optically anisotropic layer may be integrally laminated, or one of the upper and lower optically anisotropic layers may serve as a support.

In the liquid crystal display device of the invention, the transparent support of the optically anisotropic layer may serve also the protective layer on one side of the polarizer. Accordingly, in FIG. 1, a transparent protective film, a polarizer, a transparent protective film (this serves also as a transparent support) and an optically anisotropic layer are laminated in that order to form a monolithic polarizing plate. The polarizing plate not only has a polarizing function but also contributes to broadening the viewing angle of the device and reducing display unevenness in the device. Further, since the polarizing plate is provided with an optically anisotropic layer having an optical compensatory function, it additionally serves for accurate optical compensation in the liquid crystal display device though having a simple constitution. In the liquid crystal display device, it is desirable that a transparent protective film, a polarizer, a transparent support and an optically anisotropic layer are laminated in that order from the outer side of the device (from the side remoter from the liquid crystal cell in the device).

The absorption axes 2 and 15 of the polarizer, the alignment direction of the protective films 3 and 12, and the alignment direction of the liquid crystalline molecules 7 may be controlled within an optimum range in accordance with the materials of the members, the display mode and the laminate structure of the members. For obtaining a high contrast, the members are so disposed that the absorption axes 2 and 15 of the polarizing plates 1 and 14 may be substantially perpendicular to each other. However, the liquid crystal display device of the invention should not be limited to that constitution.

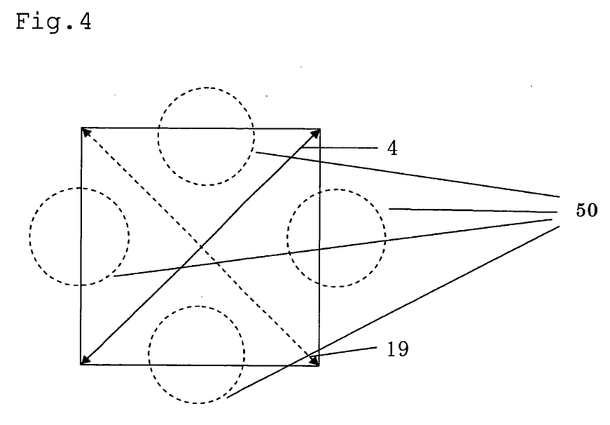

In a cross-Nicol state of a conventional polarizing plate with no optical compensatory sheet therein, light leakage occurs in observation at four sites in the oblique direction as shown by 50 in FIG. 4 at the time of black level of display, and the viewing angle is narrowed in these 4 directions.

On the other hand, the liquid crystal display device I has an optically anisotropic layer comprising a hybrid-aligned compound, between the liquid crystal cell and the polarizer in at least one polarizing plate, and this is so constituted that the alignment control direction of the hybrid-aligned compound could be nearly in parallel to absorption axis of any one polarizer in the liquid crystal display device (in the embodiment of FIG. 1, the alignment control direction 11 of the lower optically anisotropic layer 10 is nearly in parallel to the absorption axis 15 of the polarizer 14a of the lower polarizing plate). The liquid crystal display device of the invention may be optically so planned that, when it is viewed in the oblique direction thereof, then the light leakage is only in two directions, and the viewing angle in the horizontal direction is narrowed and the viewing angle in the vertical direction is broadened. In particular, in case where the device has an optically anisotropic layer comprising a compound having a discotic structural unit, then the effect is remarkable. In the hybrid-aligned direction, the retardation in the oblique viewing angle direction reduces, but in the lateral direction to the alignment direction, the retardation increases in the oblique viewing angle direction and the transmittance increases whereby the image becomes whitish. The optically anisotropic layer may be disposed only on the side of the liquid crystal cell, but when it is disposed on both sides thereof, then a vertically-symmetric viewing angle characteristic can be obtained. The optically anisotropic layer may be provided on the protective film of a polarizing plate, but it may be provided directly on a polarizer. In this case, the optically anisotropic layer may serve also as a protective film of a polarizing plate.

The degree of light leakage in the oblique direction through the hybrid-aligned optically anisotropic layer mentioned above varies, depending on the thickness of the layer, d [μm], the mean tilt angle of the hybrid-aligned compound, β [°], and the in-plane retardation of the optically anisotropic layer, Q [nm].

When the layer satisfies the following formulae:
0.5≦d≦3.0,
20≦β≦90,
10≦Q≦500,
then light leakage occurs and the layer is effective for preventing peeping in the oblique direction of the device. In case where the data are smaller than these ranges, then the retardation of the optically anisotropic layer in the oblique direction may be small and the light leakage may be therefore small. On the other hand, when the data are larger than these ranges, then the transmittance through the device may greatly lower and the panel may color.

In the invention, “alignment control direction” may be, for example, the rubbing direction of the alignment film to be mentioned hereinunder.

The liquid crystal display device II additionally comprises a polarizing plate having at least one optically anisotropic layer and disposed on the outer surfaces of a pair of polarizing plates, in which the optically anisotropic layer comprises a hybrid-aligned compound and the alignment control direction of the hybrid-aligned compound is nearly in parallel to absorption axis of at least any one of the polarizers in the liquid crystal display device. Having the constitution, therefore, the liquid crystal display device II may be so optically planned that the viewing angle in the horizontal direction thereof is narrowed and the viewing angle in the vertical direction thereof is broadened, like the liquid crystal display device I. In the invention, in addition, the optically anisotropic layer may be sandwiched between substrates such as glass plates or polyimide films having a transparent electrode formed thereon, and the alignment in the layer may be varied by an external field such as an external electric field applied thereto to thereby change the viewing angle characteristic of the device.

The in-plane retardation value is equivalent to the above-mentioned Re, and the thickness-direction retardation value is to the above-mentioned Rth, and these are the sum total of the values of the transparent support, the optically anisotropic layer and the liquid crystal layer disposed between the above-mentioned pair of polarizers. Regarding the positivity and the negativity thereof, the value is positive when the slow axis is in the direction parallel to the alignment axis of the liquid crystal layer, and it is negative when the slow axis is in the direction vertical to it. In case where the compound having a discotic structural unit is so aligned that its discotic surface is vertical to the substrate surface, then the value is positive when the discotic surface and the alignment axis of the liquid crystal layer are in parallel to each other, and the value is negative when the two are perpendicular to each other.

Preferably, Re of the protective film of the upper polarizing plate that is disposed on the side toward the liquid crystal layer (upper protective film) is smaller than Rth of the protective film of the lower polarizing plate on the side toward the liquid crystal layer (lower protective film). Accurately planning Re and Rth of the upper protective film and the lower protective film makes it possible to more completely prevent light leakage in the oblique direction of the device at the time of black level of display. More preferably, Re of the upper protective film is smaller by at least 20 nm than Rth of the lower protective film.

[IPS Mode Liquid Crystal Display Device]

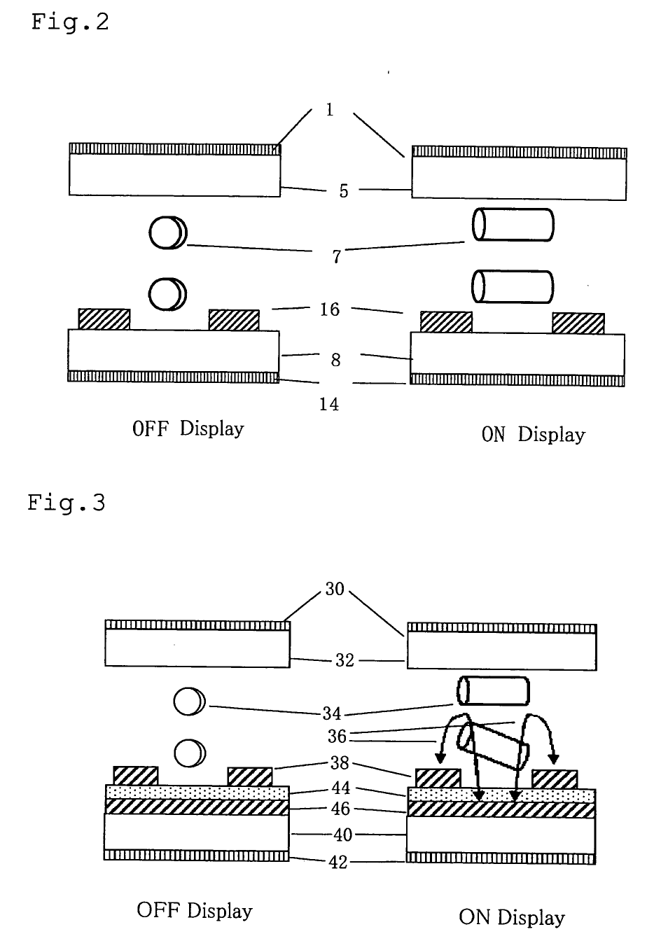

FIG. 2 is a schematic cross-sectional side view showing an IPS mode liquid crystal cell. This has a pair of polarizing plates 1 and 14 and an IPS mode liquid crystal cell. The pair of polarizing plates have a protective film, a polarizer and an optical compensatory film, but in FIG. 2, the detailed structure is omitted. The IPS mode liquid crystal cell has a pair of transparent substrates 5 and 8, and a liquid crystal layer sandwiched between the pair of substrates and containing rod-shaped liquid crystalline molecules 7. Inside the transparent substrate 8, formed are linear electrodes 16, and an alignment control film (not shown) is formed thereon. The plural linear electrodes 16 are spaced from each other, and constitute a pixel electrode and a counter electrode in such a manner that a parallel electric field may be generated between the substrates. The rod-shaped liquid crystalline molecules 7 sandwiched between the substrates 5 and 8 are so aligned that they are at some angle relative to the lengthwise direction of the linear electrode 16 at the time of no electric field application thereto (OFF time). In this stage, the dielectric anisotropy of the liquid crystal is presumed to be positive. When an electric field is applied between the electrodes 16 (ON time), then the liquid crystalline molecules 7 turn their direction toward the electric field direction. The polarizing plates 1 and 14 may be disposed that their transmission axes are at a certain angle, whereby the light transmittance through the device may be changed. The angle of the electric field direction to the surface of the substrate 8 is preferably at most 20 degrees, more preferably at most 10 degrees, or that is, it is desirable that the two are substantially in parallel to each other. The electric field at an angle of at most 20 degrees is hereinafter generically referred to as a parallel electric field. The electrodes may be formed on both the upper and lower substrates or may be formed only on one substrate with no difference in the effect of the electrodes between the two.

FIG. 3 is a schematic cross-sectional side view showing another embodiment of an IPS mode liquid crystal display device. This embodiment enables more rapid response and higher transmittance. In this, the detailed description of the same members as in FIG. 2 is omitted herein. This embodiment differs from that of FIG. 2 in that the electrodes have a two-layered structure formed in two layers via an insulating layer 44 therebetween (or that is, two layers of the electrodes are formed) to provide a linear electrode 38 and a lower electrode 46. The lower electrode 46 may be a non-patterned electrode or may be a linear electrode. The upper electrode 38 is preferably linear, but may be in any other form of a networked, spiral or dot-like pattern so far as the electric field from the lower electrode 46 may pass through it. If desired, a floating electrode having a neutral potential may be further added to the electrode structure. The insulating layer 44 may be formed of an inorganic material such as an SiO or nitride film, or an organic material such as an acrylic or epoxy film.

As the liquid crystal material LC of the IPS mode device, a nematic liquid crystal having a positive dielectric anisotropy Δε is used. The thickness (gap) of the liquid crystal layer is preferably more than 2.8 μm but less than 4.5 μm. In the invention, the product of the thickness, d (μm), of the liquid crystal layer and the refractivity anisotropy Δn, Δn·d may be from 0.2 to 1.2 μm. The optimum value of Δn·d is from 0.2 to 0.5 μm. Within the range, the white-level display brightness is high and the black-level display brightness is small, and therefore a bright and high-contrast display device can be obtained. The optimum value is the value in a transmission mode. In a reflection mode, the optical path in the liquid crystal cell is two times, and therefore the optimum value of Δn·d may be about ½ of the above-mentioned value. Depending on the combination of predetermined alignment film and polarizing plate, when the liquid crystalline molecules are rotated by 45 degrees from the rubbing direction toward the electric field direction, then the maximum transmittance may be obtained. The thickness (gap) of the liquid crystal layer may be controlled by polymer beads. Needless-to-say, glass beads or fibers, as well as resinous columnar spacers may produce the same gap. The liquid crystal material LC is not specifically defined, so far as it is a nematic liquid crystal. When the dielectric anisotropy Δε is larger, then the necessary driving voltage may be reduced more; and when the refractivity anisotropy Δn is smaller, then the thickness (gap) of the liquid crystal layer may be larger, whereby the time to be taken for liquid crystal encapsulation may be shortened and the gap fluctuation may be reduced.

Not specifically defined, the display mode of the liquid crystal display device of the invention is preferably an ECB mode or an IPS mode. Not limited to these, however, the liquid crystal display device of the invention is also effectively applicable to other VA mode, OCB mode, TN mode, HAN mode and STN mode.

Not limited to the constitution of FIG. 1, the liquid crystal display device of the invention may have any other members. For example, a color filter may be disposed between the liquid crystal cell and the polarizer. In case where the device is a transmission-type one, then a backlight having a light source of a cold-cathode or hot-cathode fluorescent tube, or a light emitting diode, a field emission element or an electroluminescent element may be disposed on the back side of the device. The liquid crystal display device of the invention may be a reflection-type one. In this type, one polarizing plate only may be disposed on the viewer's side of the device, or a reflection film may be disposed on the back side of the liquid crystal cell or on the inner surface of the lower substrate of the liquid crystal cell. Needless-to-say, a front light with a light source as above may be disposed on the viewer's side of the liquid crystal cell. In addition, the liquid crystal display device of the invention may satisfy both a transmission mode and a reflection mode, for which the device may be semitransmission-mode one where one pixel region has both a reflection site and a transmission site provided therein.

For increasing the emission efficiency of the backlight in the device, a prism-shaped or lens-shaped light-concentrating brightness-improving sheet (film) may be laminated, or a polarized light reflection-type brightness-improving sheet (film) may be laminated between the backlight and the liquid crystal cell for reducing the light loss owing to the absorption by polarizing plate. For the purpose of unifying the light source of the backlight, a diffusion sheet (film) may be laminated; and on the contrary, for producing in-plane distribution in the light source, a sheet (film) with a reflection/diffusion pattern print formed thereon may be laminated.

The liquid crystal display device of the invention includes an image direct-viewing-type device, an image projection-type device and an optical modulation-type device. As one effective embodiment thereof, the invention is favorably applied to an active matrix liquid crystal display device that comprises a three-terminal or two-terminal semiconductor element such as TFT or MIM. Needless-to-say, the invention is also effectively applicable to a passive matrix liquid crystal display device such as typically an STN mode device that may be referred to as a time-division driving mode device.

In the invention, the slow axis of the protective film of the polarizing plate and the absorption axis of the polarizer are made to be in a predetermined relation, whereby the viewing angle of the liquid crystal display device is improved; and further, an optical compensatory sheet is provided between the polarizing plate and the liquid crystal cell whereby the viewing angle is improved more. Not specifically defined, the optical compensatory sheet may have any constitution so far as it has an optical compensatory capability. For example, it includes a birefringent polymer film; and a laminate of a transparent support and an optical compensatory sheet of liquid crystalline molecules formed on the transparent support. In the latter embodiment, the transparent protective film of the polarizing plate on the side toward the liquid crystal layer may serve also as the support of the optical compensatory sheet.

The constitutive members of the liquid crystal display device of the invention are described.

In the invention, for optical compensation for the liquid crystal cell, used is an optically anisotropic layer that contains a liquid crystalline compound fixed in its alignment state. In the invention, the optically anisotropic layer is formed on a support to form an optical compensatory sheet, which may be built in the liquid crystal display device; or the optical compensatory sheet may be integrated with a linear polarizer to construct an elliptically polarizing plate, which may be built in the liquid crystal display device. Methods for producing the angle-set optical compensatory sheet and polarizing plate as above are not specifically defined, for which, for example, employable is a method of controlling the alignment control direction and the stretching direction relative to the roll-conveying direction in the step of forming an optical compensatory sheet or a polarizing plate; or a method of forming an optical compensatory sheet and a polarizing plate in a roll-to-roll process followed by blanking them at a set angle.

[Optical Compensatory Sheet]

An example of the optical compensatory sheet usable in the invention comprises an optically transparent support and an optically anisotropic layer of a liquid crystalline compound formed on the support. Using the optical compensatory sheet in a liquid crystal display device makes it possible to optically compensate the liquid crystal cell in the device not worsening the other properties of the device.

The constitutive components of the optical compensatory sheet are described.

<<Support>>

The optical compensatory sheet may have a support. The direction of the slow axis of the transparent support on which an optically compensatory layer is formed is not specifically defined, but is preferably from −50° to 50° relative to the alignment control direction (for example, the rubbing direction) of the liquid crystalline compound, more preferably −45±5° or 45°±5°, or −5° to 5°. Preferably, the support is glass or a transparent polymer film. Preferably, the support has a light transmittance of at least 80%. Examples of the polymer that constitutes the polymer film include cellulose ester (e.g., cellulose mono to tri-acylate), norbornene-based polymer and polymethyl methacrylate. Commercially-available polymer (e.g., Arton and Zeonex (both trade names) of norbornene-based polymer) are also usable herein. Conventional known polycarbonate and polysulfone that may readily express birefringence may be subjected to molecular modification for birefringence expression control, as in WO 00/26705, and the thus-modified polymers are preferably used herein.

Above all, cellulose ester is preferred; and lower fatty acid ester of cellulose is more preferred. The lower fatty acid means a fatty acid having at most 6 carbon atoms. In particular, cellulose acylate in which the ester moiety has from 2 to 4 carbon atoms is preferred, and cellulose acetate is more preferred. Mixed fatty acid esters such as cellulose acetate propionate and cellulose acetate butyrate are also usable herein. Preferably, the viscosity-average degree of polymerization (DP) of cellulose acetate is at least 250, more preferably at least 290. Also preferably, cellulose acetate has a narrow molecular weight distribution of MW/Mn (where Mw is a mass-average molecular weight, and Mn is a number-average molecular weight) as determined through gel permeation chromatography. Concretely, Mw/Mn is preferably from 1.0 to 1.7, more preferably from 1.0 to 1.65.

For the polymer film, preferably used is cellulose acetate having a degree of acetylation of from 55.0 to 62.5%. The degree of acetylation is more preferably from 57.0 to 62.0%. The degree of acetylation means the bound acetic acid amount per the unit mass of cellulose. The degree of acetylation may be determined according to ASTM:D-817-91 (test method for cellulose acetate) for measurement and computation of a degree of acetylation.

In cellulose acetate, the 2-, 3- and 6-positioned hydroxyls in cellulose are not uniformly substituted but the substitution degree at the 6-position may tend to be low. In the polymer film for use in the invention, it is desirable that the substitution degree at the 6-position in cellulose is comparable to or higher than that at the 2- or 3-position. The ratio of the substitution degree at the 6-substitution to the overall substitution degree at the 2-, 3- and 6-substitutions is preferably from 30 to 40%, more preferably from 31 to 40%, most preferably from 32 to 40%. Preferably, the substitution degree at the 6-substitution is at least 0.88.

Concrete acyl groups and methods for producing cellulose acylate are described in detail in Hatsumei Kyokai Disclosure Bulletin No. 2001-1745 (issued Mar. 15, 2001), page 9.

The preferred range of the retardation value of the polymer film varies, depending on the liquid crystal cell in which the optical compensatory film is used and on the method of using it. Preferably, the in-plane retardation Re of the film is from 0 to 200 nm, and the thickness-direction retardation Rth thereof is from 70 to 400 nm. In case where two optically anisotropic layers are used in the liquid crystal display device, then Rth of the polymer film is preferably within a range of from 70 to 250 nm. In case where one optically anisotropic layer is used in the liquid crystal display device, then Rth of the substrate is preferably within a range of from 150 to 400 nm.

The birefringence (Δn: nx−ny) of the substrate film is preferably within a range of from 0.00028 to 0.020. The birefringence in the thickness direction of the cellulose acetate film {(nx+ny)/2−nz} is preferably within a range of from 0.001 to 0.04.

For controlling the retardation of the polymer film, generally employed is a method of imparting an external force such as stretching to the film, for which, however, a retardation-increasing agent may be used for optical anisotropy control. For controlling the retardation of the cellulose acylate film, preferably used is an aromatic compound having at least two aromatic ring for the retardation-increasing agent. The aromatic compound is preferably used in an amount of from 0.01 to 20 parts by mass relative to 100 parts by mass of cellulose acylate. Two or more different types of aromatic compounds may be used, as combined. The aromatic ring of the aromatic compound includes an aromatic hetero ring in addition to an aromatic hydrocarbon ring. For example, herein usable are aromatic compounds described in EP-A-911656, JP-A-2000-111914 and JP-A-2000-275434.

The moisture absorption expansion coefficient of the cellulose acetate film to be used for the optical compensatory sheet in the invention is preferably at most 30×10⁻⁵% RH, more preferably at most 15×10⁻⁵% RH, even more preferably at most 10×10⁻⁵% RH. The moisture absorption expansion coefficient is preferably smaller, but in general, it is 1.0×10⁻⁵/% RH or more. The moisture absorption expansion coefficient indicates the length change of a sample when the ambient relative humidity is varied at a constant temperature. By controlling the moisture absorption expansion coefficient, the frame-like transmittance increase (deformation-caused light leakage) of the optical compensatory sheet may be prevented while the optical compensatory function thereof is kept as such.

A method of determining the moisture absorption expansion coefficient is described. A produced polymer film is cut to give a sample having a width of 5 mm and a length of 20 mm. With its one end fixed, the sample is hung in an atmosphere at 25° C. and 20% RH (R₀). A weight of 0.5 g is fitted to the other end of the sample, and the sample is left as such for 10 minutes, and its length (L₀) is measured. Next, while the temperature is kept 25° C., the humidity is changed to 80% RH (R₁), and the length (L₁) of the sample is measured. Based on the measured data, the moisture absorption expansion coefficient of the film is calculated according to the following formula. 10 samples in all are tested for one film, and the data are averaged for the measured data.
Moisture Absorption Expansion Coefficient [/% RH]={(L₁−L₀)/L₀}/(R₁−R₀)

For reducing the dimension change of the polymer film owing to the moisture absorption thereof, it is desirable that a hydrophobic group-having compound or fine particles are added to the film. For the hydrophobic group-having compound, especially preferably used are the corresponding materials of plasticizers and degradation inhibitors having a hydrophobic group such as an aliphatic group or an aromatic group. The amount of the compound to be added is preferably from 0.01 to 10% by mass of the solution (dope) to be prepared. In addition, the free volume in the polymer film may be reduced. Concretely, the residual solvent amount in film formation according to a solution casting method to be mentioned below may be reduced for reducing the free volume of the film. Preferably, the cellulose acetate film is dried under the condition under which the residual solvent content of the dried film could be from 0.01 t 1.00% by mass.

The above-mentioned additives and other additives that may be added to the polymer film in accordance with various objects thereof (e.g., UV absorbent, release agent, antistatic agent, degradation inhibitor (e.g., antioxidant, peroxide decomposer, radical inhibitor, metal inactivator, acid scavenger, amine), IR absorbent) may be solid or oily. In case where the film has a multi-layered structure, then the type and the amount of the additives to be added to each layer may differ. The details of the additives are described in Disclosure Bulletin No. 2001-1745, pp. 16-22, and those described therein are preferably used herein. The amount of the additives to be used is not specifically defined so far as the additives added could exhibit their function. Preferably, the amount is within a range of from 0.001 to 25% by mass of the whole composition of the polymer film.

<<Method for Producing Polymer Film (Support)>>

The polymer film is preferably produced according to a solution casting method. In the solution casting method, a polymer material is dissolved in an organic solvent to prepare a solution (dope), and this is formed into a film. The dope is cast onto a drum or a band, and the solvent is evaporated away to form a film thereon. Before cast, the concentration of the dope is preferably so controlled that the solid content thereof could be from 18 to 35%. Preferably, the surface of the drum or the band is mirror-finished.

The dope is preferably cast onto a drum or a band at 10° C. or lower. Preferably, the cast film is dried by exposing it to air for at least 2 seconds. The resulting film is peeled from the drum or band, and it may be dried with hot air at a gradually-varying temperature of from 100° C. up to 160° C. to thereby evaporate away the residual solvent. The method is described in JP-B-5-17844. According to the method, the time taken from casting to peeling may be shortened. For carrying out the method, the dope must gel at the surface temperature of the drum or the band onto which the dope is cast.

In the casting step, one cellulose acylate solution may be cast to form a single layer; or two or more cellulose acylate solutions may be co-cast simultaneously and/or successively.

For co-casting plural cellulose acylate solutions to form 2 or more layers as in the above, for example, herein employable are a method of casting cellulose acylate-containing solutions through plural casting port disposed at intervals in the support-running direction and laminating the resulting films (e.g., method described in JP-A-11-198285); a method of casting cellulose acylate solutions through two casting ports (e.g., method described in JP-A-6-134933); a method of enveloping a flow of a high viscosity cellulose acylate solution with a low viscosity cellulose acylate solution and simultaneously co-extruding the high viscosity cellulose acylate solution and the low viscosity cellulose acylate solution (e.g., method described in JP-A-56-162617). However, the invention should not be limited to these methods. The solution casting methods are described in detail in Disclosure Bulletin No. 2001-1745, pp. 22-30, in which dissolution, casting (including co-casting), metal support, drying, peeling and stretching are grouped for their description.

In the invention, the thickness of the film (support) is preferably from 15 to 120 μm, more preferably from 30 to 80 μm.

<<Surface Treatment of Polymer Film (Support)>>

Preferably, the polymer film is subjected to surface treatment. The surface treatment includes corona discharge treatment, glow discharge treatment, flame treatment, acid treatment, alkali treatment and UV irradiation treatment. These are described in detail in Disclosure Bulletin No. 2001-1745, pp. 30-32. Of those, especially preferred is alkali saponification treatment, which is extremely effective for surface treatment of cellulose acylate films.

For the alkali saponification treatment, the film may be dipped in a saponification solution, or a saponification solution may be applied to the film. Preferred is the latter coating method. The coating method includes a dipping method, a curtain-coating method, an extrusion-coating method, a bar-coating method and an E-type coating method. The alkali saponification solution includes an aqueous potassium hydroxide solution and an aqueous sodium hydroxide solution, in which the hydroxide ion normality concentration is preferably within a range of from 0.1 to 3.0 N. The alkali processing solution may contain a solvent having a good wettability to the film (e.g., isopropyl alcohol, n-butanol, methanol, ethanol); a surfactant, and a wetting agent (e.g., diols, glycerin). Containing these, the saponification solution may have a good wettability to transparent supports, and its storage stability may be bettered. Concretely, for example, referred to are the descriptions in JP-A-2002-82226 and WO 02/46809.

In place of the surface treatment or in addition to the surface treatment, herein employable is a single-layer method of forming one layer of an undercoat layer (as in JP-A-7-333433) or a resin layer of gelatin or the like that contains both a hydrophobic group and a hydrophilic group; or a double-layer method of forming a first layer well adhesive to a polymer film (hereinafter referred to as a first undercoat layer) and further forming thereon a second hydrophilic resin layer of gelatin or the like well adhesive to the overlying alignment film (hereinafter referred to as a second undercoat layer) (for example, as in JP-A-11-248940).

<<Alignment Film>>

In the invention, the liquid crystalline compound in the optically anisotropic layer is alignment-controlled by an alignment axis, and is fixed as its aligned state. The alignment axis for the alignment control of the liquid crystalline compound is, for example, the rubbing axis of the alignment film formed between the optically anisotropic layer and the polymer film (support). In the invention, however, the alignment axis is not limited to the rubbing axis, and it may be any one capable of serving for alignment control of the liquid crystalline compound like the rubbing axis.

The alignment film has a function of defining the alignment direction of liquid crystalline molecules. Accordingly, the alignment film is indispensable for realizing the preferred embodiment of the invention. However, when the alignment state of the liquid crystalline compound is fixed after the compound has been aligned, then the alignment film could fill its role, and therefore it is not always indispensable as the constitutive element of the invention. Specifically, only the optically anisotropic layer on the alignment film of which the alignment state has been fixed may be transferred onto a polarizer to fabricate a polarizing plate.

The alignment film may be provided by rubbing treatment of an organic compound (preferably polymer), oblique deposition of an inorganic compound, formation of a layer having microgrooves, or accumulation of an organic compound (e.g., ω-tricosanoic acid, dioctadecylmethylammonium chloride, methyl stearate) by a Langmuir-Blodgett process (LB film). Further known are alignment films capable of having an alignment function generated through application of an electric field or a magnetic field thereto or through irradiation thereof with light.

The alignment film is preferably formed through rubbing of polymer. The polymer to be used for the alignment film has, in principle, a molecular structure having a function of aligning liquid crystalline molecules. In the invention, in addition to the function of the polymer of aligning liquid crystalline molecules, it is desirable that side branches having a crosslinking functional group (e.g., double bond) are bonded to the main chain of the polymer or a crosslinking functional group having a function of aligning liquid crystal line molecules is introduced into the side branches of the polymer. The polymer to be used for the alignment film may be either a polymer self-crosslinkable by itself or a polymer capable of being crosslinked by a crosslinking agent, and various combinations of such polymers are also usable herein. Examples of the polymer include methacrylate-based copolymer, styrene-based copolymer, polyolefin, polyvinyl alcohol and modified polyvinyl alcohol, poly(N-methylolacrylamide), polyester, polyimide, vinyl acetate copolymer, carboxymethyl cellulose, polycarbonate, as in paragraph [0022] in JP-A-8-338913. A silane coupling agent may also be used as the polymer. Water-soluble polymers (e.g., poly(N-methylolacrylamide), carboxymethyl cellulose, gelatin, polyvinyl alcohol, modified polyvinyl alcohol) are preferred; gelatin, polyvinyl alcohol and modified polyvinyl alcohol are more preferred; and polyvinyl alcohol and modified polyvinyl alcohol are most preferred. Especially preferably, two or more different types of polyvinyl alcohol and modified polyvinyl alcohol that differ in the degree of polymerization thereof are combined for use herein.

The degree of saponification of polyvinyl alcohol is preferably from 70 to 100%, more preferably from 80 to 100%; and the degree of polymerization of polyvinyl alcohol is preferably from 100 to 5000.

Side branches having a function of aligning liquid crystalline molecules generally have a hydrophobic group as a functional group. The concrete type of the functional group may be determined depending on the type of the liquid crystalline molecules and on the necessary alignment state thereof. For example, the modifying group of modified polyvinyl alcohol may be introduced through copolymerization modification, chain transfer modification or block polymerization modification. Examples of the modifying group include a hydrophilic group (e.g., carboxylic acid group, sulfonic acid group, phosphonic acid group, amino group, ammonium group, amido group, thiol group), a hydrocarbon group having from 10 to 100 carbon atoms, a fluorine atom-substituted hydrocarbon group, a thioether group, a polymerizing group (e.g., unsaturated polymerizing group, epoxy group, aziridinyl group), an alkoxysilyl group (e.g., trialkoxy, dialkoxy, monoalkoxy). Examples of the modified polyvinyl alcohol compound are described, for example, in JP-A-2000-155216, paragraphs [0022] to [0145]; and JP-A-2002-62426, paragraphs [0018] to [0022].

When side branches having a crosslinking functional group are bonded to the main chain of the alignment film polymer, or when a crosslinking functional group is introduced into the side branches of the polymer having a function of aligning liquid crystalline molecules, then the polymer of the alignment film and the polyfunctional monomer contained in the optically anisotropic layer may be copolymerized. As a result, not only between the polyfunctional monomer and the polyfunctional monomer but also between the alignment polymer and the alignment polymer and even between the polyfunctional monomer and the alignment polymer, the two may be firmly bonded to each other via covalent bonding. Accordingly, by introducing the crosslinking functional group into the alignment film polymer, the strength of the optical compensatory sheet can be remarkably increased.

Preferably, the crosslinking functional group in the alignment film polymer contains a polymerizing group, like the polyfunctional monomer. Concretely, for example, referred to are the descriptions in JP-A-2000-155216, paragraphs [0080] to [0100].

Apart from the above-mentioned crosslinking functional group, the alignment film polymer may be crosslinked with a crosslinking agent. The crosslinking agent includes aldehydes, N-methylol compounds, dioxane derivatives, carboxyl group-activating compounds, active vinyl compounds, active halogen compounds, isoxazoles and dialdehyde starch. Two or more different types of crosslinking agents may be combined for use herein. Concretely, for example, herein usable are the compounds described in JP-A-2002-62426, paragraphs [0023] to [0024]. Aldehydes of high reactivity are preferred, and glutaraldehyde is especially preferred.

The amount of the crosslinking agent to be added to the polymer is preferably from 0.1 to 20% by mass, more preferably from 0.5 to 15% by mass of the polymer. Preferably, the amount of the unreacted crosslinking agent to remain in the alignment film is at most 1.0% by mass, more preferably at most 0.5% by mass. Controlling the amount in that manner enables good durability with no reticulation of the alignment film in liquid crystal display devices that may be used for a long period of time or may be left in a high-temperature high-humidity atmosphere for a long period of time.

Basically, the alignment film may be formed by applying an alignment film-forming material containing a polymer and a crosslinking agent as above onto a transparent support, then heating and drying it (for crosslinking it), and rubbing it. The crosslinking reaction may be attained at any time after the film-forming material has been applied onto a transparent film, as so mentioned hereinabove. In case where a water-soluble polymer such as polyvinyl alcohol is sued in the alignment film-forming material, then it is desirable that the coating solution is formed in a mixed solvent of an organic solvent having a defoaming capability (e.g., methanol) and water. The ratio by mass of water/methanol is preferably from 0/100 to 99/1, more preferably from 0/100 to 91/9. Using the mixed solvent prevents the coating solution from foaming, and the surface defects of the formed alignment film or the optically anisotropic layer may greatly reduce.

For forming the alignment film, preferably employed is a spin-coating method, a dipping method, a curtain-coating method, an extrusion-coating method, a rod-coating method or a roll-coating method. Especially preferred is a rod-coating method. After dried, the thickness of the film is preferably from 0.1 to 10 μm. The heating and drying may be effected at 20° C. to 110° C. For forming sufficient crosslinking, the heating is preferably at 60° C. to 100° C., more preferably at 80° C. to 100° C. The drying time may be from 1 minute to 36 hours, preferably from 1 minute to 30 minutes. Preferably, the pH in the method is set optimally for the crosslinking agent used. In case where glutaraldehyde is used, the pH is preferably from 4.5 to 5.5, more preferably 5.

The alignment film may be provided on a transparent support or on the above-mentioned undercoat layer. The alignment film may be formed after crosslinking the polymer layer as above and then rubbing the surface of the layer.

For the rubbing treatment, any method widely employed as a step of liquid crystal alignment treatment for LCD is usable herein. Specifically, the surface of the alignment film is rubbed in one direction, using paper, gauze, felt, rubber or nylon, or polyester fibers, whereby the film may obtain the intended alignment. In general, using a cloth produced by uniformly planting fibers having a uniform length and a uniform thickness, the film is rubbed a few times for the alignment treatment.

Next, owing to the function of the alignment film, the liquid crystalline molecules in the optically anisotropic layer formed on the alignment film are aligned. After it, if desired, the alignment film polymer is reacted with the polyfunctional monomer contained in the optically anisotropic layer, or the alignment film polymer is crosslinked with a crosslinking agent. Preferably, the thickness of the alignment film is within a range of from 0.1 to 10 μm.

<<Optically Anisotropic Layer>>

Preferred embodiments of the optically anisotropic layer that comprises a liquid crystalline compounds are described in detail.

Preferably, the optically anisotropic layer is so planned that it could compensate the liquid crystal compound in the liquid crystal cell at the time of black level of the liquid crystal display device. The alignment state of the liquid crystal compound in the liquid crystal cell at the time of black level of display differs depending on the mode of the liquid crystal display device. Regarding the alignment state of the liquid crystal compound in the liquid crystal cell, referred to are the descriptions in IDW′ 00, FMC7-2, pp. 411-414. The optically anisotropic layer is controlled for its alignment by the alignment axis such as the rubbing axis, and the liquid crystalline compound in the layer is fixed as the alignment state of the layer.

Examples of the liquid crystalline molecules to be used in the optically anisotropic layer include rod-shaped liquid crystalline molecules and discotic liquid crystalline molecules (liquid crystal line molecules having a discotic structural unit). The rod-shaped liquid crystalline molecules and the discotic liquid crystalline molecules may be high-molecular liquid crystals or low-molecular liquid crystals, further including crosslinked low-molecular liquid crystals that do not exhibit liquid crystallinity as they are crosslinked. In case where a rod-shaped liquid crystalline compound is used in forming the optically anisotropic layer, then the rod-shaped liquid crystalline molecules are preferably so aligned that the mean direction of their major axes as projected onto the support surface is parallel to the alignment axis of the molecules. In case where a discotic liquid crystalline compound is used in forming the optically anisotropic layer, then the discotic liquid crystalline molecules are preferably so aligned that the mean direction of their minor axes as projected onto the support surface is parallel to the alignment axis of the molecules. The optically anisotropic layer in the liquid crystal display device of the invention comprises a hybrid-aligned compound, in which the angle (tilt angle) between the major axis of the liquid crystalline molecules (discotic face of discotic molecules) and the layer face varies in the depth direction of the layer, an as so mentioned hereinabove.

<<Rod-Shaped Liquid Crystalline Molecules>>

As the rod-shaped liquid crystalline molecules, preferably used are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans and alkenylcyclohexylbenzonitriles.

The rod-shaped liquid crystalline molecules include metal complexes. Liquid crystal polymers that contain a rod-shaped liquid crystalline molecule in the repetitive unit are also usable as rod-shaped liquid crystalline molecules. In other words, the rod-shaped liquid crystalline molecules for use herein may bond to (liquid crystal) polymer.

The rod-shaped liquid crystalline molecules are described in Quarterly Outline of Chemistry, No. 22, Chemistry of Liquid Crystal (1994) by the Chemical Society of Japan, Chap. 4, Chap. 7 and Chap 11; and Liquid Crystal Device Handbook edited by the 142nd Commission of the Academic Promotion of Japan, Chap. 3.

The birefringence of the rod-shaped liquid crystalline molecules is preferably within a range of from 0.001 to 0.7.

Preferably, the rod-shaped liquid crystalline molecules have a polymerizing group for fixing their alignment state. The polymerizing group is preferably a radical-polymerizing unsaturated group or a cationic polymerizing group. Concretely, for example, the polymerizing groups and the polymerizing liquid crystal compounds described in JP-A-2002-62427, paragraphs [0064] to [0086] are referred to.

<<Discotic Liquid Crystalline Molecules>>

The discotic liquid crystalline molecules include benzene derivatives described in C. Destrade et al's study report, Mol. Cryst., Vol. 71, p. 111 (1981); toluxene derivatives described in C. Destrade et al's study report, Mol. Cryst., Vol. 122, p. 141 (1985), Physics Lett. A, Vol. 78, p. 82 (1990); cyclohexane derivatives described in B. Kohne et al's study report, Angew. Chem., Vol. 96, p. 70 (1984); and azacrown-type and phenylacetylene-typemacrocycles described in J. M. Lehn et al's study report, J. Chem. Commun., p. 1794 (1985), J. Zhang et al's study report, J. Am. Chem. Soc., Vol. 116, p. 2655 (1994)

The discotic liquid crystalline molecules include those having a structure in which a linear alkyl group, alkoxy group, or substituted benzoyloxy group is radially bonded to the mother nucleus at the center of the molecule, as a side branch of the mother nuclei, and exhibiting liquid crystallinity. Preferably, the compound is so constituted that the molecules or the aggregate of the molecules have a rotary symmetry and can be aligned in a certain direction. Regarding the optically anisotropic layer formed of the discotic liquid crystalline molecules, it is not always necessary that the compounds finally to be in the optically anisotropic layer are discotic liquid crystalline molecules. For example, low-molecular discotic liquid crystalline molecules may have a group reactive under heat or light, and as a result, the molecules may be polymerized or crosslinked by heat or light to give high-molecular compounds not having liquid crystallinity. Those high-molecular compounds having lost liquid crystallinity are also within the scope of the discotic liquid crystal molecules as referred to herein. Preferred examples of the discotic liquid crystalline molecules for use herein are described in JP-A-8-50206. Polymerization of discotic liquid crystalline molecules is described in JP-A-8-27284.

For fixing the discotic liquid crystalline molecules through polymerization, a polymerizing group must be bonded as a substituent to the discotic core of the discotic liquid crystalline molecules. Preferably, the discotic core and the polymerizing group bond to each other via a lining group, and the compound having the constitution of the type may keep its alignment stage through polymerization. For example, referred to are the compound described in JP-A-2000-155216, paragraphs [0151] to [0168].

In hybrid alignment, the angle between the major axis of the liquid crystalline molecules (disc face of discotic molecules) and the layer face increases or decreases with the increase in the distance from the surface of the polarizer in the thickness direction of the optically anisotropic layer. Preferably, the angle increases with the increase in the distance. Further, the angle change may be continuous increase, continuous decrease, intermittent increase, intermittent decrease, combination of continuous increase and continuous decrease, or intermittent change including increase and decrease. The intermittent change includes a region where the tilt angle does not change in the course of the thickness direction. The angle may include a region with no angle change, so far as it increases or decreases as a whole. Preferably, the angle continuously changes.

The mean direction of the major axes of the liquid crystalline molecules on the side of the polarizer may be controlled generally by selecting the material for the liquid crystalline molecules or the alignment film, or by selecting the rubbing method. The direction of the major axes of the liquid crystalline molecules (discotic face of discotic molecules) on the surface side (air side) may be controlled generally by selecting the liquid crystalline molecules and the type of the additives to be used along with the liquid crystalline molecules. Examples of the additives to be used along with the liquid crystalline molecules include plasticizer, surfactant, polymerizing monomer and polymer. The degree of the change of the major axis in the alignment direction may also be controlled by selecting the liquid crystalline molecules and the additives, like in the above.

<<Other Additives in Optically Anisotropic Layer>>

Plasticizer, surfactant and polymerizing monomer may be used along with the above-mentioned liquid crystalline molecules, thereby improving the uniformity of the coating film, the strength of the film, and the alignment of the liquid crystalline molecules in the film. Preferably, the additives are compatible with the liquid crystalline molecules, and are capable of changing the tilt angle of the liquid crystalline molecules or do not detract from the alignment of the liquid crystalline molecules.

The polymerizing monomer includes radical-polymerizing or cationic-polymerizing compounds. Preferred are a polyfunctional radical-polymerizing monomer. Also preferred is a monomer capable of copolymerizing with the above-mentioned, polymerizing group-having liquid crystalline compound. For example, herein usable are those described in JP-A-2002-296423, paragraphs [0018] to [0020]. The amount of the compound to be added may be generally from 1 to 50% by mass, preferably from 5 to 30% by mass of the discotic liquid crystalline molecules.

The surfactant may be any known compound, and is preferably a fluorine-containing compound. Concretely, for example, herein usable are the compounds described in JP-A-2001-330725, paragraphs [0028] to [0056].

The polymer usable along with the discotic liquid crystalline molecules is preferably one capable of changing the tilt angle of the discotic liquid crystalline molecules.

An example of the polymer is cellulose ester. Preferred examples of the cellulose ester are described in JP-A-2000-155216, paragraph [0178]. In order not to detract from the alignment of the liquid crystalline molecules, the amount of the polymer to be added is preferably from 0.1 to 10% by mass, more preferably from 0.1 to 8% by mass of the liquid crystalline molecules. The discotic nematic liquid crystal phase/solid phase transition temperature of the discotic liquid crystalline molecules is preferably from 70 to 300° C., more preferably from 70 to 170° C.

<<Formation of Optically Anisotropic Layer>>

The optically anisotropic layer may be formed by applying a coating solution, which contains liquid crystalline molecules and optionally a polymerization initiator to be mentioned hereinunder and other optional additives, onto an alignment film.

The solvent to be used in preparing the coating solution is preferably an organic solvent. Examples of the organic solvent include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane, tetrachloroethane), esters (e.g., methyl acetate, butyl acetate), ketones (e.g., acetone, methyl ethyl ketone), ethers (e.g., tetrahydrofuran, 1,2-dimethoxyethane). Preferred are alkylhalides and ketones. Two or more different types of organic solvents may be combined for use herein.

Coating with the coating solution may be attained in any known method (e.g., wire bar-coating method, extrusion-coating method, direct gravure-coating method, reverse gravure-coating method, die-coating method).

The thickness of the optically anisotropic layer is preferably from 0.1 to 20 μm, more preferably from 0.5 to 15 μm, most preferably from 1 to 10 μm.

<<Fixation of Alignment State of Liquid Crystalline Molecules>>

The aligned liquid crystalline molecules may be fixed while they keep their aligned state. The fixation is preferably attained by polymerization. The polymerization includes thermal polymerization using a thermal polymerization initiator and optical polymerization using an optical polymerization initiator. Optical polymerization is preferred. Examples of the optical polymerization initiator include α-carbonyl compounds (as in U.S. Pat. No. 2,367,661, U.S. Pat. No. 2,367,670), acyloin ethers (as in U.S. Pat. No. 2,448,828), α-hydrocarbon-substituted aromatic acyloin compounds (as in U.S. Pat. No. 2,722,512), polycyclic quinone compounds (as in U.S. Pat. No. 3,046,127, U.S. Pat. No. 2,951,758), combination of triarylimidazole dimer and p-aminophenyl ketone (as in U.S. Pat. No. 3,549,367), acridine and phenazine compounds (as in JP-A-60-105667, U.S. Pat. No. 4,239,850), and oxadiazole compounds (as in U.S. Pat. No. 4,212,970).

The amount of the optical polymerization initiator to be used is preferably from 0.01 to 20% by mass of the solid content of the coating solution, more preferably from 0.5 to 5% by mass.

For the light irradiation for polymerization of liquid crystalline molecules, preferably used is UV light. The irradiation energy is preferably from 20 mJ/cm² to 50 J/cm², more preferably from 20 to 5000 mJ/cm², even more preferably from 100 to 800 mJ/cm². For promoting the optical polymerization, the light irradiation may be effected under heat.

A protective layer may be provided above the optically anisotropic layer.

The optical compensatory sheet not formed of a discotic compound includes an optical compensatory sheet formed of a stretched birefringent polymer film, and an optical compensatory sheet having an optical compensatory layer of a low-molecular or high-molecular liquid crystalline compound formed on a transparent support. The optical compensatory sheet may have a laminate structure, for example, a two-layered laminate optical compensatory film. In consideration of its thickness, the laminate-structured optical compensatory sheet is preferably one formed according to a coating method, rather than a laminate of stretched polymer films.

The polymer film to be used for the optical compensatory sheet may be a stretched polymer film or a combination of a polymer layer formed by coating and a polymer film. For the material of the polymer film, generally used is a synthetic polymer (e.g., polycarbonate, polysulfone, polyether sulfone, polyacrylate, polymethacrylate, norbornene resin, triacetyl cellulose).

A liquid crystalline compound may have various alignment states, and therefore the optical compensatory layer formed of a liquid crystalline compound may have a single-layered structure or a multi-layered laminate structure to express desired optical properties. Specifically, the optical compensatory sheet may comprise a support and one or more optically anisotropic layers formed on the support. The overall retardation of the optical compensatory sheet of this embodiment may be controlled by the optical anisotropy of the optically anisotropic layers constituting it. Liquid crystalline compounds may be grouped into rod-shaped liquid crystalline compounds and discotic liquid crystalline compounds from their shape. They include low-molecular and high-molecular types, and any of these are usable herein. The optically anisotropic layer of the liquid crystalline compounds for use in the invention preferably comprises a rod-shaped liquid crystalline compound or a discotic liquid crystalline compound (more preferably, a discotic liquid crystalline compound), and even more preferably, it comprises a polymerizing group-having discotic liquid crystalline compound.

<<Elliptically-Polarizing Plate>>

In the invention, an elliptically-polarizing plate where the above-mentioned optically anisotropic layer is integrated with a linear polarizer may be used. Preferably, the elliptically-polarizing plate is so shaped that it may have a form nearly the same as that of the pair of substrates of constituting a liquid crystal cell in order that it may be directly built in a liquid crystal display device (for example, when the liquid crystal cell is rectangular, then the elliptically-polarizing plate is preferably shaped to have the same rectangular form). The liquid crystal display device of the invention is so constituted that, in the optically anisotropic layer disposed in a predetermined site, the alignment control direction of the hybrid-aligned compound is nearly in parallel to any one absorption axis of the polarizer, as so mentioned hereinabove.

The elliptically-polarizing plate may be fabricated by laminating the above-mentioned optical compensatory sheet and a linear polarizer (“polarizer” mentioned hereinafter is meant to indicate “linear polarizer” unless otherwise specifically indicated). The optically anisotropic layer may serve also as the protective film for the linear polarizer.

The linear polarizer is preferably a polarizer formed by coating, such as typically by Optiva Inc., or a polarizer comprising a binder and iodine or a dichroic dye. Iodine and the dichroic dye in the linear polarizer expresses a polarization capability, after aligned in a binder. Preferably, iodine and the dichroic dye are aligned along the binder molecules, or the dichroic dye is aligned in one direction through self-organization like liquid crystal. At present, commercially-available polarizers are produced by dipping a stretched polymer in a solution of iodine or a dichroic dye in a bath to thereby make the iodine or dichroic dye penetrate into the binder.

In a commercially-available polarizer, iodine or a dichroic dye is distributed in about 4 μm from the polymer surface (in about 8 μm in total on both sides), and for obtaining a sufficient polarization capability, the thickness of the film is at least 10 μm. The degree of penetration may be controlled by controlling the iodine or dichroic dye solution concentration, the temperature of the bath and the dipping time. As so mentioned hereinabove, the lowermost limit of the binder thickness is preferably 10 μm. Regarding the uppermost limit of the thickness, the thickness is preferably as small as possible from the viewpoint of the prevention of light leakage from the liquid crystal display device. Preferably, it is not larger than the thickness of commercially-available polarizing plates (about 30 μm), more preferably it is at most 25 μm, even more preferably at most 20 μm. When the thickness is at most 20 μm, then no light leakage is observed in 17-inch liquid crystal display devices.

The binder to be contained in the polarizer may be crosslinked. For the crosslinked binder, usable is a self-crosslinkable polymer. A functional group-having polymer or a binder obtained by introducing a functional group into a polymer may be reacted between the binder through application of light, heat or pH change thereto, whereby the polarizer may be formed. A crosslinked structure may be introduced into the polymer by the use of a crosslinking agent. In general, the crosslinking may be attained by applying a coating solution that contains a polymer or a mixture of a polymer and a crosslinking agent, onto a transparent support, and heating it. Since it is enough that the final product may have durability, the crosslinking treatment may be effected in any stage of finally giving the polarizing plate. Examples of the polymer may be the same as those mentioned hereinabove in the section of the alignment film. Most preferred are polyvinyl alcohol and modified polyvinyl alcohol. Modified polyvinyl alcohol is described in JP-A-8-338913, JP-A-9-152509, JP-A-9-316127. Two or more different types of polyvinyl alcohol and modified polyvinyl alcohol may be used, as combined. The amount of the crosslinking agent to be added to the binder is preferably from 0.1 to 20% by mass of the binder. In that manner, the alignment of the polarizing element and the wet heat resistance of the polarizer are bettered.

After the crosslinking reaction, the polarizer may contain an unreacted crosslinking agent in some degree. However, the amount of the residual crosslinking agent is preferably at most 1.0% by mass, more preferably at most 0.5% by mass of the polarizer. In that manner, the degree of polarization of the polarizer may be prevented from being lowered even after the polarizer has been built in a liquid crystal display device and used for a long period of time or left in a high-temperature high-humidity atmosphere for a long period of time.

The crosslinking agent is described in US Reissue 23297. Boron compounds (e.g., boric acid, borax) may also be used as the crosslinking agent.

The dichroic dye includes, for example, azo dyes, stilbene dyes, pyrazolone dyes, triphenylmethane dyes, quinoline dyes, oxazine dyes, thiazine dyes and anthraquinone dyes. The dichroic dye is preferably soluble in water. The dichroic dye preferably has a hydrophilic substituent (e.g., sulfo, amino, hydroxy).

Examples of the dichroic dye are, for example, the compounds described Disclosure Bulletin No. 2001-1745, page 58.

For increasing the contrast ratio of the liquid crystal display device, it is desirable that the transmittance of the polarizing plate therein is higher and the degree of polarization thereof is also higher. Preferably, the transmittance of the polarizing plate is within a range of from 30 to 50% at a wavelength of 550 nm, more preferably from 35 to 50%, most preferably from 40 to 50%. Preferably, the degree of polarization is within a range of from 90 to 100% at a wavelength of 550 nm, more preferably from 95 to 100%, most preferably from 99 to 100%.

<<Production of Elliptically-Polarizing Plate>>

The elliptically-polarizing plate may be produced according to a stretching method or a rubbing method. In the stretching method, the draw ratio in stretching is preferably from 2.5 to 30.0 times, more preferably from 3.0 to 10.0 times. The stretching may be dry stretching in air. It may also be wet stretching while dipped in water. The draw ratio in dry stretching is preferably from 2.5 to 5.0 times; and the draw ratio in wet stretching is preferably from 3.0 to 10.0 times. In the stretching step, oblique stretching may be effected a few times. Stretching the film a few times makes it possible to stretch the film more uniformly to a high draw ratio. Before oblique stretching, the film may be stretched in the cross or machine direction in some degree (in such a degree that the cross shrinkage of the film could be prevented). The stretching may be attained by the use of a tenter for biaxial stretching, for which the right side and the left side of the film are stretched differently. The biaxial stretching may be the same as that generally attained in ordinary film formation. In the biaxial stretching, the film is stretched at different right and left speeds, in which, therefore, the thickness of the binder film before stretched must differ between the right side and the left side of the film. In film formation by casting, the die to be used may be tapered to thereby differentiate the flow rate of the binder solution between the right side and the left side of the film to be formed.

To the rubbing treatment, a rubbing method widely employed for liquid crystal alignment treatment in LCD may be applied. Specifically, the surface of the film is rubbed in one direction, using paper, gauze, felt, rubber or nylon, or polyester fibers, whereby the film may obtain the intended alignment. In general, using a cloth produced by uniformly planting fibers having a uniform length and a uniform thickness, the film is rubbed a few times for the alignment treatment. Preferably, the degree of circularity, the degree of cylindricality, and the degree of decentering (eccentricity) of the rubbing roll for use herein are all at most 30 μm. The lapping angle of the rubbing roll to the film is preferably from 0.1 to 90°. However, the film may be wound around the roll by 360° C. or more to thereby obtain stable rubbing treatment, as in JP-A-8-160430.

For rubbing a long-size film, it is desirable that the film is conveyed by a conveyor under constant tension at a speed of from 1 to 100 m/min. The rubbing roll is preferably set rotatably in the horizontal direction relative to the film-traveling direction for setting a desired rubbing angle. Preferably, the suitable rubbing angle is selected within a range of from 0 to 60°. In case where the rubbed film is used in a liquid crystal display device, then the rubbing angle is preferably from 40 to 50°, more preferably 45°.

On the surface opposite to the optically anisotropic layer of the linear polarizer, a polymer film is preferably disposed (to have a configuration of optically anisotropic layer/polarizer/polymer film).

Preferably, the polymer film is coated with an anti-staining and scratch-resistant antireflection film on its outermost surface. The antireflection film may be any known one.

### EXAMPLES

The invention is described in more detail with reference to the following Examples and Comparative Examples. In the following Examples, the material used, its amount and the ratio, the details of the treatment and the treatment process may be suitably modified or changed not overstepping the sprit and the scope of the invention. Accordingly, the invention should not be limitatively interpreted by the Examples mentioned below. Unless otherwise specifically indicated, “%” in the following description is by mass.

### Example 1

A liquid crystal display device having the constitution shown in FIG. 1 was fabricated. Briefly, an upper polarizing plate 1, an upper protective film 3, a liquid crystal cell (upper substrate 5, liquid crystal layer 7, lower substrate 8), a lower optically anisotropic layer 10, and a lower polarizing plate 12 were laminated in that order from the viewing side (upper side),; and below the lower polarizing plate, disposed was a backlight with a cold-cathode fluorescent tube (not shown). The constitutive members and methods for producing them are described below.

(Formation of IPS Mode Liquid Crystal Cell)

FIG. 2 shows a cross-sectional view of the liquid crystal display device fabricated herein. On the inner side of one substrate 8 of a pair of substrates, formed is a linear electrode of ITO (this may be a metal such as chromium or aluminium); and an alignment control film (not shown) is formed on it. The rod-shaped liquid crystalline molecules 7 sandwiched between the substrates are so aligned that they may be at some angle to the lengthwise direction of the linear electrode at the time of no electric field application thereto. In this case, the dielectric anisotropy of the liquid crystal is presumed to be positive. When an electric field is applied thereto, then the liquid crystalline molecules 7 change their direction toward the electric field. With that, the polarizing plates 1 and 14 are disposed at a predetermined angle, whereby the light transmittance through the device may be changed. Regarding the electric field direction in point of its angle to the surface of the substrate 8, the electric field is a parallel electric field. The parallel electric field as referred to herein means that the angle of the electric field direction to the surface of the substrate is at most 20 degrees, more preferably at most 10 degrees, even more preferably in parallel to each other, as so mentioned hereinabove. The electrode may be formed on both the upper and lower substrates or on one electrode alone with no difference in the effect between the two.

The liquid crystal material used is a nematic liquid crystal (Merck's MLC 9100-100) having a positive dielectric anisotropy Δε of 13.2 and a refractivity anisotropy Δn of 0.085 (589 nm, 20 degrees). The thickness (gap) of the liquid crystal layer is 3.5 μm.

<Formation of Cellulose Acetate Film>

The following composition was put into a mixing tank and stirred under heat to dissolve the constitutive components to prepare a cellulose acetate solution.

Composition of Cellulose Acetate Solution:

| | |
|---|---|
| Cellulose Acetate having a degree of acetylation of | 100 parts by mass |
| from 60.7 to 61.1% | |
| Triphenyl Phosphate (plasticizer) | 7.8 parts by mass |
| Biphenyldiphenyl phosphate (plasticizer) | 3.9 parts by mass |
| Methylene Chloride (first solvent) | 336 parts by mass |
| Methanol (second solvent) | 29 parts by mass |
| 1-Butanol (third solvent) | 11 parts by mass |

16 parts by mass of a retardation-increasing agent mentioned below, 92 parts by mass of methylene chloride and 8 parts by mass of methanol were put into another mixing tank, and stirred under heat to prepare a retardation-increasing agent solution. 25 parts by mass of the retardation-increasing agent solution was mixed with 474 parts by mass of the cellulose acetate solution, and well stirred to prepare a dope. The amount of the retardation-increasing agent added was 6.0 parts by mass relative to 100 parts by mass of cellulose acetate.

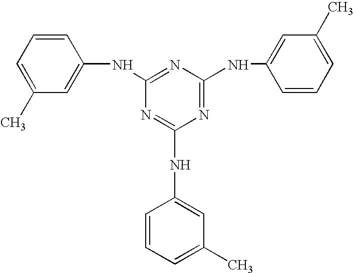

The resulting dope was cast, using a band stretcher. After the film temperature on the band became 40° C., the film on the band was dried with hot air at 70° C. for 1 minute and then with dry air at 140° C. for 10 minutes to produce a cellulose acetate film (thickness, 80 μm) having a residual solvent content o 0.3% by mass. The thus-produced cellulose acetate film (transparent support, transparent protective film) was analyzed for its Re and Rth at a wavelength of 546 nm, using an ellipsometer (Nippon Bunko's M-150). Re was 8 nm, and Rth was 78 nm. The produced cellulose acetate film was dipped in 2.0 mol/L potassium hydroxide solution (25° C.) for 2 minutes, then neutralized with sulfuric acid, and washed with pure water, and then dried. The process gave a cellulose acetate film for transparent protective film.

<Production of Alignment Film for Optically Anisotropic Layer>

On the cellulose acetate film, a coating solution having the composition mentioned below was applied in an amount of 28 mL/m², using a wire bar coater #16. This was dried with hot air at 60° C. for 60 seconds and then with hot air at 90° C. for 150 seconds. Next, the formed film was so rubbed as to be aligned in the direction parallel to the in-plane slow axis of the cellulose acetate film (in the direction parallel to the casting direction) (that is, the rubbing axis was in parallel to the slow axis of the cellulose acetate film).

Composition of Alignment Film Coating Solution:

| | | |
|---|---|---|
| Modified Polyvinyl alcohol mentioned below | 20 | parts by mass |
| Water | 360 | parts by mass |
| Methanol | 120 | parts by mass |
| Glutaraldehyde (crosslinking agent) | 1.0 | parts by mass |

Modified Polyvinyl Alcohol:

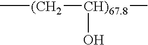

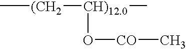

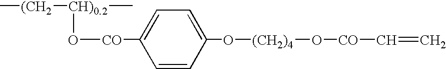

<Formation of Optically Anisotropic Layer>

A coating solution prepared by dissolving 91.0 g of a discotic (liquid crystalline) compound mentioned below, 9.0 g of ethylene oxide-modified trimethylolpropane triacrylate (Osaka Organic Chemistry's V#360), 2.0 g of cellulose acetate butyrate (Eastman Chemical's CAB551-0.2), 0.5 g of cellulose acetate butyrate (Eastman Chemical's CAB531-1), 3.0 g of an optical polymerization initiator (Ciba-Geigy's Irgacure 907), 1.0 g of a sensitizer (Nippon Kayaku's Kayacure DETX) and 1.3 g of a fluoroaliphatic group-containing copolymer (Dai-Nippon Ink's Megafac F780) in 207 g of methyl ethyl ketone, was applied onto the alignment film in an amount of 6.2 mL/m² using a wire bar coater #3.6. This was heated in a thermostat zone at 130° C. for 2 minutes whereby the discotic compound was aligned. Next, this was exposed to UV light from a 120 W/cm high-pressure mercury lamp in an atmosphere at 60° C. for 1 minutes to thereby polymerize the discotic compound. Next, this was kept cooled to room temperature. The process formed an optically anisotropic layer, therefore producing an optical compensatory sheet.

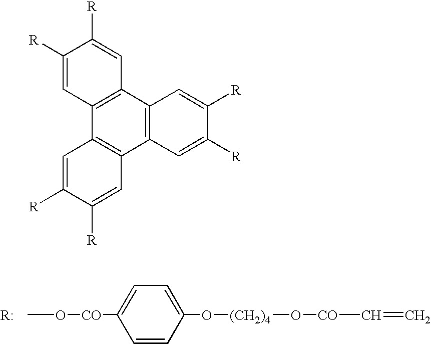

Polarizing plates were combined in a cross-Nicol configuration, in which the optical compensatory sheet was checked for unevenness. As a result, no unevenness was found both in the front direction and in the oblique direction from the normal line up to 60 degrees.

<Formation of Polarizing Plate>

Iodine was made to be adsorbed by a stretched polyvinyl alcohol film to produce a polarizer. Using a polyvinyl alcohol-based adhesive, the optical compensatory sheet produced in the above was stuck to one side of the polarizer with its substrate surface facing the polarizer. On the other hand, a commercially-available cellulose acetate film (Fiji Photo Film's Fujitac TD80UF) was saponified, and using a polyvinyl alcohol-based adhesive, this was stuck to the opposite side of the polarizer. These were so disposed that the absorption axis of the polarizer could be in parallel to the slow axis of the support of the compensatory sheet (in parallel to the casting direction). This polarizing plate was stuck to one side of the IPS mode liquid crystal cell produced in the above, in such a manner that the alignment control direction 11 of the optically anisotropic layer 10 could be in perpendicular to the rubbing direction 9 of the liquid crystal cell and that the discotic liquid crystal-coated surface could face the liquid crystal cell. Next, a commercially-available polarizing plate (Sanritz's HLC2-5618) 1 was stuck to the other upper side of the IPS mode liquid crystal cell, in a cross-Nicol configuration to construct a liquid crystal display device. Re of the protective film of the polarizing plate was 3 nm, and Rth thereof was 38 nm.

On the basis of the horizontal direction of the display device, the axial angle of the absorption axis of the upper polarizing plate and the polarizer was set 0 degree; the slow axis of the upper protective film was 0 degree; the alignment control direction (rubbing direction) of the upper substrate of the liquid crystal cell was 0 degree; the axial angle of the lower polarizing plate was similarly 0 degree; the alignment control direction of the lower optically anisotropic layer was 90 degrees; the alignment control direction (rubbing direction of the lower substrate of the liquid crystal cell was 90 degrees; the slow axis of the lower protective layer was 90 degrees; and the absorption axis of the lower polarizer was 90 degrees. Accordingly, in this liquid crystal display device, the alignment control direction 11 of the optically anisotropic layer 10 is nearly in parallel to the absorption axis 15 of the polarizer 14a.

<Photometry of Produced Liquid Crystal Display Device>

A rectangular wave voltage of 60 Hz was applied to the liquid crystal display device produced in the above. This is in normally black mode with a white display level of 5 V and a black display level of 2 V. Using a photometer, EZ-Contrast 160D (by ELDIM), the transmittance ratio (white display level/black display level), or that is the contrast ratio of the device was determined. The front contrast ratio was 700/1. The viewing angle to obtain a contrast of at least 10 in the horizontal direction was 40 degrees both in the right side and the left side directions. On the other hand, the viewing angle to obtain the contrast of at least 10 in the upper direction was 80°, and that in the lower direction was 85°.

### Example 2

In the liquid crystal display device produced in Example 1, an optically anisotropic layer (upper optically anisotropic layer) of a hybrid-aligned discotic compound was disposed between the upper protective film and the liquid crystal cell, and the alignment control direction of the upper optically anisotropic layer was set at 90 degrees. The other constitution is the same as in Example 1. The viewing angle to obtain a contrast of at least 10 in the horizontal direction was 40 degrees both in the right side and the left side directions. The viewing angle to obtain the contrast of at least 10 in the upper and lower directions was 85°, respectively.

### Comparative Example 1

A commercially-available polarizing plate (Sanritz's HLC2-5618) was stuck to both sides of the IPS mode liquid crystal cell produced in Example 1, in a cross-Nicol configuration to construct a liquid crystal display device. In this, an optically anisotropic layer was not used. The viewing angle to obtain a contrast o at least 10 was 85° in all the horizontal and vertical directions.

Comparing Examples 1 and 2 with Comparative Example 1, it is understood that, when the hybrid-aligned optically anisotropic layer and the polarizer are so configured that the alignment control direction of the former is nearly in parallel to the absorption axis of the latter, then the viewing angle in the horizontal direction of the device can be narrowed while the viewing angle in the vertical direction can be kept as such. In addition, it is confirmed that, in Examples 1 and 2, the brightness reduction in the front was lowered little and the brightness in the horizontal direction at the time of black level of display increased.

### Example 3

An optically anisotropic layer-fitted polarizing plate that had been produced in the same manner as in Example 1 was disposed on the surface of an IPS panel-mounted, commercially-available liquid crystal TV, Hitachi's WO 00/7000. The absorption axis direction of the polarizing plate on the front side of the commercially-available TV was 90°; the absorption axis direction of the added polarizing plate was also 90°; and the alignment control direction of the optically anisotropic layer was also 90°. The viewing angle to obtain a contrast of at least 10 in the vertical direction was 85° in the commercially-available TV, and it was reduced to 40° after modified as herein. On the other hand, the viewing angle to obtain a contrast of at least 10 in the vertical direction of the modified TV was 85°, which was the same as that in the commercially-available TV. Accordingly, this Example confirms the following: When a hybrid-aligned optically anisotropic layer-having polarizing plate is disposed on the outer side of the polarizing plate and when the optically anisotropic layer and the polarizer are so configured that the alignment control direction of the former is nearly in parallel to the absorption axis of the latter, then only the viewing angle in the horizontal direction could be narrowed while the viewing angle in the vertical direction is kept as such. In addition, in Example 3, it is also confirmed that the brightness reduction in the front was little and the brightness in the horizontal direction at the time of black level of display increased.

### Example 4

A liquid crystal display device was constructed in the same manner as in Example 3, in which, however, the optically anisotropic layer of the optically anisotropic layer-fitted polarizing plate in the device of Example 3 was replaced by a liquid crystal cell. The liquid crystal cell was fabricated as follows: Two solid ITO electrode-fitted glass substrates having a size of 50 mm×40 mm were used. A vertically-aligned film was applied to one substrate, and a horizontally-aligned film was to the other substrate. These were rubbed to produce a hybrid-aligned cell. The liquid crystal material was, for example, Merck's ZLI4792; and the cell gap was 5 μm.

At the time of no voltage application thereto, the viewing angle of the device to have a contrast of at least 10 in the horizontal direction was 40°; and that in the vertical direction was 85°. When an alternating rectangular wave of 5 V at a frequency of 30 Hz was applied to the device, then the viewing angle to obtain a contrast of at least 10 was 85° in all the vertical and horizontal directions, like commercially-available TVs. At the time of no electric field application thereto, the alignment control direction of the hybrid-aligned cell was in a state of nearly in parallel to the absorption axis of the polarizer, and therefore, as compared with the case where an electric field is applied to the device, the viewing angle in the horizontal direction could be narrowed. In addition, in Example 4, it is also confirmed that the brightness reduction in the front was little and the brightness at the time of black level of display in the horizontal direction increased.

As described in detail with reference to its preferred embodiments hereinabove, the liquid crystal display device of the invention is favorable to display devices for mobile phones or mobile terminals (notebook-size personal computers).

The present disclosure relates to the subject matter contained in Japanese Patent Application No. 234684/2005 filed on Aug. 12, 2005, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A liquid crystal display device comprising
a liquid crystal cell that comprises a pair of substrates disposed to face each other and having an electrode on one side thereof, and a liquid crystal layer sandwiched between the substrates and containing a nematic liquid crystal material aligned nearly in parallel to the surfaces of the pair of substrates at the time of no voltage application thereto, and
two polarizing plates disposed on both outer sides of the liquid crystal cell,
wherein at least one of the polarizing plates comprises a polarizer and a protective film disposed on at least one surface of the polarizer, and an optically anisotropic layer is disposed between the liquid crystal cell and the polarizer provided that the optically anisotropic layer and one of the protective films may be the same, and
the optically anisotropic layer comprises a hybrid-aligned compound, and the alignment control direction of the hybrid-aligned compound is nearly in parallel to absorption axis of any one of the polarizers provided in the liquid crystal display device.

2. The liquid crystal display device according to claim 1, wherein the optically anisotropic layer is disposed on both sides of the liquid crystal cell.

3. The liquid crystal display device according to claim 1, wherein the alignment state of at least one optically anisotropic layer varies depending on the external field around it.

4. The liquid crystal display device according to claim 1, wherein the optically anisotropic layer comprises a compound having a discotic structural unit, and satisfies the following formulae:
0.5≦d≦3.0,
20≦β≦90,
10≦Q≦500,
in which d [μm] indicates the thickness of the optically anisotropic layer; β [°] indicates the mean tilt angle of the hybrid-aligned compound in the optically anisotropic layer; and Q [nm] indicates the in-plane retardation of the optically anisotropic layer.

5. A liquid crystal display device comprising
a liquid crystal cell that comprises a pair of substrates disposed to face each other and having an electrode on one side thereof, and a liquid crystal layer sandwiched between the substrates and containing a nematic liquid crystal material aligned nearly in parallel to the surfaces of the pair of substrates at the time of no voltage application thereto,
two first polarizing plates comprising a polarizer and disposed on both outer sides of the liquid crystal cell, and
a second polarizing plate comprising a polarizer and an optically anisotropic layer and disposed outside the first polarizing plates,
wherein the second polarizing plate comprises a protective film disposed on at least one surface of the polarizer, and the optically anisotropic layer is disposed between the polarizer and the first polarizing plate provided that the optically anisotropic layer and one of the protective films in the second polarizing plate may be the same, and
the optically anisotropic layer comprises a hybrid-aligned compound, and the alignment control direction of the hybrid-aligned compound is nearly in parallel to absorption axis of any one of the polarizers provided in the liquid crystal display device.

6. The liquid crystal display device according to claim 5, wherein the alignment state of at least one optically anisotropic layer varies depending on the external field around it.

7. The liquid crystal display device according to claim 5, wherein the optically anisotropic layer comprises a compound having a discotic structural unit, and satisfies the following formulae:
0.5≦d≦3.0,
20≦β≦90,
10≦Q≦500,
in which d [μm] indicates the thickness of the optically anisotropic layer; β [°] indicates the mean tilt angle of the hybrid-aligned compound in the optically anisotropic layer; and Q [nm] indicates the in-plane retardation of the optically anisotropic layer.
